(19) United States
(12) Patent Application Publication
(10) Pub. No.: US 2026/0180703 A1
(43) Pub. Date: Jun. 25, 2026

(54) COMMUNICATION DEVICE, TIME SYNCHRONIZATION SYSTEM, AND RECORDING MEDIUM

(71) Applicant: Mitsubishi Electric Corporation, Tokyo (JP)

(72) Inventor: Kanako IIZUKA, Tokyo (JP)

(73) Assignee: Mitsubishi Electric Corporation, Tokyo (JP)

(21) Appl. No.: 19/124,306

(22) PCT Filed: Apr. 11, 2023
(86) PCT No.: PCT/JP2023/014676

§ 371 Date: Apr. 25, 2025

(51) Int. Cl. H04J 3/06

(52) U.S. Cl. CPC H04J 3/0638

(57) ABSTRACT

A time synchronization system includes a synchronization management unit and a synchronization management unit, each of which executes a time synchronization process based on a first time of a certain clock. The synchronization management unit is connected to a network, and executes a time synchronization process with a general unit included in another communication device connected via the network. The synchronization management unit is connected to a network different from the network, and executes a time synchronization process with general units included in still another communication devices connected via the network.

### TECHNICAL FIELD

The present disclosure relates to a communication device, a time synchronization system, a time synchronization method, and a program.

### BACKGROUND ART

In industrial control systems, a number of communication devices are connected to each other via a network. These communication devices connected to the network synchronize the times of their built-in clocks with each other, and can thus achieve synchronization control of operating at the same input and output timings (for example, Patent Literature 1).

For example, an industrial network based on the CC-Link IE TSN (registered trademark) achieves network synchronization communication by means of a time synchronization function based on the IEEE 1588 protocol defined in Non Patent Literature 1 or the IEEE 802.1AS protocol defined in Non Patent Literature 2. The time synchronization function matches the times of communication devices in the same network to each other and thus provides the same input and output timings.

In an industrial network having the time synchronization function based on a protocol, such as IEEE 1588 protocol or IEEE 802.1AS protocol, one communication device serves as a synchronization management unit that manages the reference time, and communication devices other than the synchronization management unit serve as general units managed by the synchronization management unit. Each of the general units calculates a time difference of the time of the general unit from the time of the synchronization management unit, on the basis of a propagation delay time between the synchronization management unit and the general unit, and matches the time of the general unit to the time of the synchronization management unit.

The communication system disclosed in Patent Literature 1 includes first and second communication devices in the same network, of which the times are matched to each other by the time synchronization function based on the propagation delay time, and multiple third communication devices connected to either of the communication devices via system buses. Each of the first and second communication devices performs the time synchronization function and thus repetitively notifies each of the third communication devices, connected to the first or second communication device via the system bus, of the current time common to the communication devices in the same network. Patent Literature 1 describes that the time synchronization function can thus match, to the time retained by the communication devices in a single network, the times of other communication devices connected to any of the communication devices via system buses.

### CITATION LIST

### Patent Literature

Patent Literature 1: International Publication No. WO 2020/194714

### Non Patent Literature

Non Patent Literature 1: IEEE Std. 1588-2008, “IEEE Standard for a Precision Clock Synchronization Protocol for Networked Measurement and Control Systems”
Non Patent Literature 2: IEEE Std. 802.1AS-2020, “IEEE Standard for Local and Metropolitan Area Networks-Timing and Synchronization for Time-Sensitive Applications”

### SUMMARY OF INVENTION

### Technical Problem

The time synchronization function based on a protocol, such as IEEE 1588 protocol or IEEE 802.1AS protocol, can only achieve time synchronization among the communication devices in the same network. This function cannot match the times of communication devices in mutually different networks, and thus is incapable of synchronization control across networks. The number of communication devices connectable to a single network is limited, which is equal to the number of communication devices capable of synchronization control.

The communication system disclosed in Patent Literature 1, in which multiple communication devices in a single network synchronize their time with other communication devices connected to any of the communication devices via system buses, is incapable of time synchronized control across networks. Desired is a technique for time synchronized control among communication devices belonging to different networks.

An objective of the present disclosure, which has been accomplished in view of the above situations, is to provide a communication device, a time synchronization system, a time synchronization method, and a program that can achieve time synchronization across networks.

### Solution to Problem

In order to achieve the above objective, a communication device according to a first aspect of the present disclosure includes a first synchronization management unit and a second synchronization management unit each configured to execute a time synchronization process based on a first time of a certain clock. The first synchronization management unit is connected to a first network, and executes a time synchronization process with a first general unit, which is included in another communication device connected to the communication device via the first network. The second synchronization management unit is connected to a second network different from the first network, and executes a time synchronization process with a second general unit, which is included in still another communication device connected to the communication device via the second network.

A communication device according to a second aspect of the present disclosure includes a first general unit connected to a first network, and a third synchronization management unit connected to a third network different from the first network. The first general unit executes a time synchronization process with a first synchronization management unit, which is included in another communication device connected to the communication device via the first network. The third synchronization management unit executes a time synchronization process based on a second time synchronized by the first general unit, with a third general unit, which is included in still another communication device connected to the communication device via the third network.

### Advantageous Effects of Invention

According to the aspects of the present disclosure, multiple synchronization management units synchronize their time with general units connected via mutually different networks, or a synchronization management unit executes a time synchronization process, via a network different from the network including the synchronization management unit with which a general unit synchronizes the time, with another general unit. This configuration can thus achieve time synchronization across networks.

### BRIEF DESCRIPTION OF DRAWINGS

FIG. 1 is a block diagram illustrating an exemplary entire configuration of a time synchronization system according to an embodiment;

FIG. 2 is a block diagram illustrating an exemplary hardware configuration of a communication device;

FIG. 3 is a block diagram illustrating an exemplary functional configuration of a communication device;

FIG. 4 is a block diagram illustrating an exemplary functional configuration of another communication device;

FIG. 5 is a block diagram illustrating an exemplary functional configuration of still another communication device;

FIG. 6 is a flowchart illustrating time synchronization;

FIG. 7 is a flowchart illustrating a time synchronization process;

FIG. 8 is a table illustrating exemplary times retained by individual communication devices at several timings;

FIG. 9 is a block diagram illustrating an exemplary entire configuration of a time synchronization system according to a modification; and

FIG. 10 is a block diagram illustrating an exemplary entire configuration of a time synchronization system according to another modification.

### DESCRIPTION OF EMBODIMENTS

### Embodiment

The following describes an embodiment of the present disclosure in detail with reference to the accompanying drawings. In the drawings, the components identical or corresponding to each other are provided with the same reference symbol.

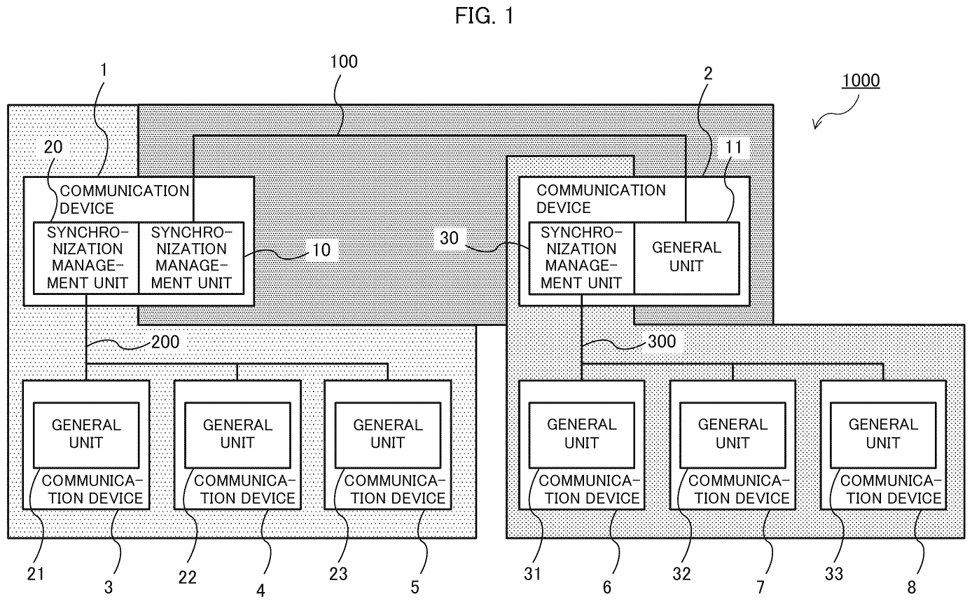

FIG. 1 is a block diagram illustrating an exemplary entire configuration of a time synchronization system 1000 according to an embodiment. The time synchronization system 1000 is an industrial control system that executes time synchronized control, for example. The time synchronization system 1000 includes multiple networks and multiple communication devices connected to any of the networks. Although FIG. 1 illustrates an exemplary configuration of the time synchronization system 1000 including networks 100, 200, and 300 and communication devices 1 to 8 connected to any of the networks, the configuration may have any number of networks, any number of communication devices, and any connections.

The networks in the embodiment are each a closed network to which a limited number of communication devices can be connected. A typical example of the networks is a network based on the CC-Link IE TSN (registered trademark).

The communication device 1 serving as a first communication device is connected to the mutually different networks 100 and 200, and includes a synchronization management unit 10 of the network 100 and a synchronization management unit 20 of the network 200. The synchronization management unit 10 is a first synchronization management unit that manages a general unit 11 connected to the network 100 serving as a first network. The synchronization management unit 20 is a second synchronization management unit that manages general units 21 to 23 connected to the network 200 serving as a second network. The general unit 11 is a first general unit included in the communication device 2 serving as a second communication device, which is connected to the communication device 1 serving as the first communication device. The general units 21 to 23 are second general units respectively included in the communication devices 3 to 5 serving as third communication devices, which are connected to the communication device 1 serving as the first communication device.

The communication device 2 serving as the second communication device is connected to the network 100 and still another network 300, and includes a synchronization management unit 30 of the network 300, and the general unit 11 of the network 100. The synchronization management unit 30 is a third synchronization management unit that manages general units 31 to 33 connected to the network 300 serving as a third network. The general units 31 to 33 are third general units respectively included in the communication devices 6 to 8 serving as third communication devices, which are connected to the communication device 2 serving as the second communication device.

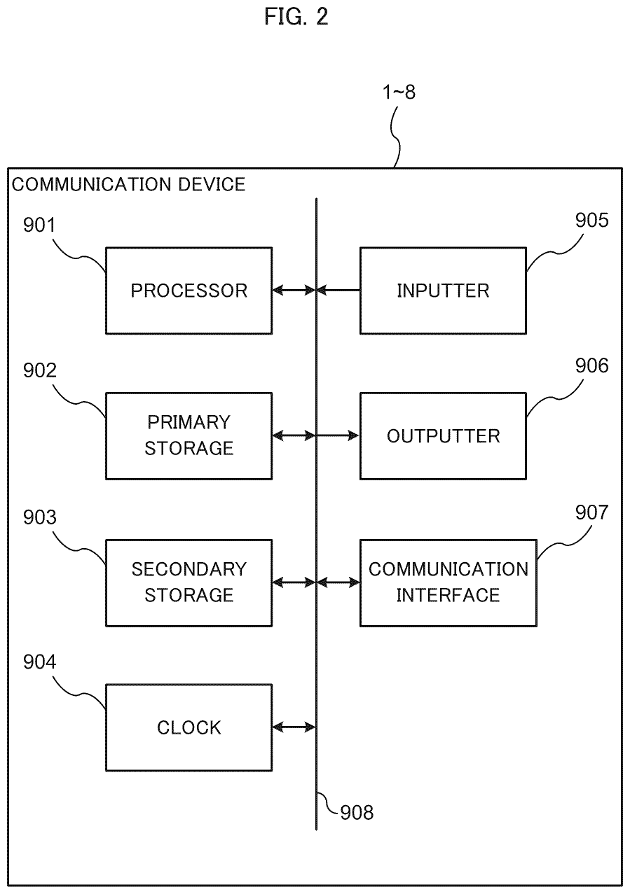

FIG. 2 illustrates a hardware configuration of each of the communication devices 1 to 8. The communication devices 1 to 8 are each included in an apparatus, such as actuator or robot, for executing time synchronized control in the industrial control system, for example. As illustrated in FIG. 2, each of the communication devices 1 to 8 includes a processor 901, a primary storage 902, a secondary storage 903, a clock 904, an inputter 905, an outputter 906, and a communication interface 907. The primary storage 902, the secondary storage 903, the clock 904, the inputter 905, the outputter 906, and the communication interface 907 are connected to the processor 901, via internal buses 908.

The processor 901 is a central processing unit (CPU), for example. The processor 901 reads and executes programs stored in the secondary storage 903, and thus achieves various functions of each of the communication devices 1 to 8.

The primary storage 902 is a working memory from and into which the processor 901 can rapidly read and write data in various calculations. A typical example of the primary storage 902 is a random access memory (RAM).

The secondary storage 903 stores programs for achieving various functions of each of the communication devices 1 to 8, and various types of data containing parameters to be used in processes of the processor 901. Examples of the secondary storage 903 include non-volatile semiconductor memories, such as electrically erasable programmable read-only memory (EEPROM) and flash memory, magnetic disks, and optical disks. The secondary storage 903 provides the processor 901 with data to be used by the processor 901, and stores data fed from the processor 901, in accordance with the instruction from the processor 901.

The clock 904 includes a clock generation circuit having an oscillating element. The clock 904 generates a clock signal in accordance with the number of oscillations of the oscillating element, and outputs the clock signal. A typical example of the oscillating element is a crystal oscillator. The clock signal contains clock pulses. The number of rising edges of the clock pulses is counted by the processor 901 for determining the time, for example.

The inputter 905 includes an input device, such as input key or pointing device. The inputter 905 acquires information input by a user of each of the communication devices 1 to 8, and notifies the processor 901 of the acquired information. The outputter 906 includes an output device, such as display or speaker. The outputter 906 presents various types of information to the user, in accordance with the instruction from the processor 901.

The communication interface 907 is a network interface for communication among the communication devices 1 to 8 or communication with other external devices. A typical example of the communication interface 907 is pursuant to the communication standard of the CC-Link IE TSN (registered trademark). The communication interface 907 receives signals from other devices, and outputs data indicated by these signals to the processor 901. Also, the communication interface 907 transmits signals indicating data output from the processor 901, to other devices. Although FIG. 2 illustrates a single communication interface 907 as a representative, each of the communication devices 1 to 8 may include two or more communication interfaces 907 for connection to the individual networks.

The hardware components illustrated in FIG. 2 cooperate with each other, so that each of the communication devices 1 to 8 includes a storage unit, a synchronization management unit, and a general unit. In other words, the execution of the programs stored in the secondary storage 903 by the processor 901 causes the hardware components illustrated in FIG. 2 to cooperate with each other and perform the functions of the storage unit, the synchronization management unit, and the general unit.

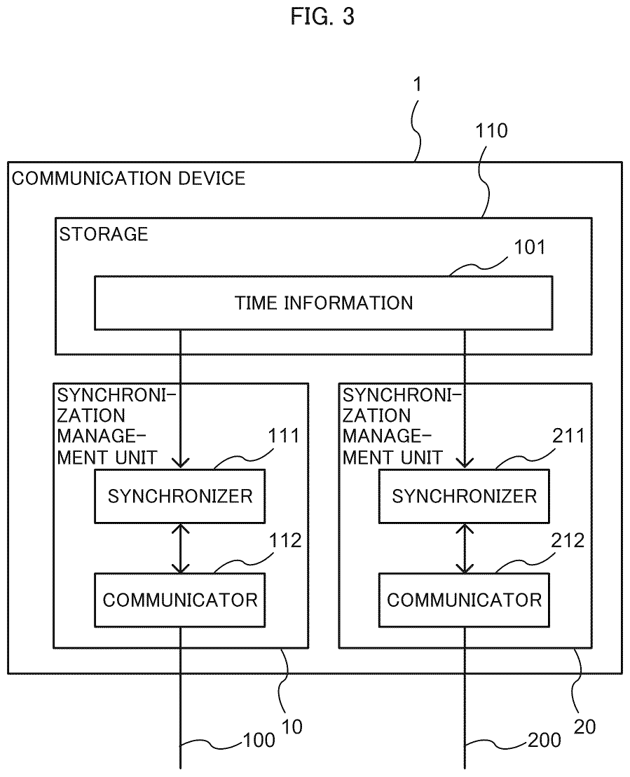

FIGS. 3 to 5 are each a block diagram illustrating a functional configuration of each of the communication devices 1 to 8. As illustrated in FIG. 3, the communication device 1 serving as the first communication device includes a storage unit 110 that stores time information 101 indicating a first time of a certain clock based on clock signals from the clock 904, the synchronization management unit 10 that executes a time synchronization process with the general unit 11 of the communication device 2 connected to the network 100, and the synchronization management unit 20 that executes a time synchronization process with the general units 21 to 23 of the communication devices 3 to 5 connected to the network 200.

The synchronization management units 10 and 20 operate on the basis of the time information 101 retained by the communication device 1. In the time synchronization system 1000, the first time indicated by the time information 101 is used as the reference time of the networks 100 and 200 to which the communication device 1 is connected, and as the reference time of the entire time synchronization system 1000.

The synchronization management unit 10 includes a synchronizer 111 (first synchronizer) that executes a time synchronization process, and a communicator 112 that communicates with the general unit 11. The synchronization management unit 20 includes a synchronizer 211 (second synchronizer) that executes a time synchronization process, and a communicator 212 that communicates with the general units 21 to 23. The time synchronization processes of the synchronizers 111 and 211 are pursuant to the IEEE 1558 protocol or the IEEE 802.1AS protocol.

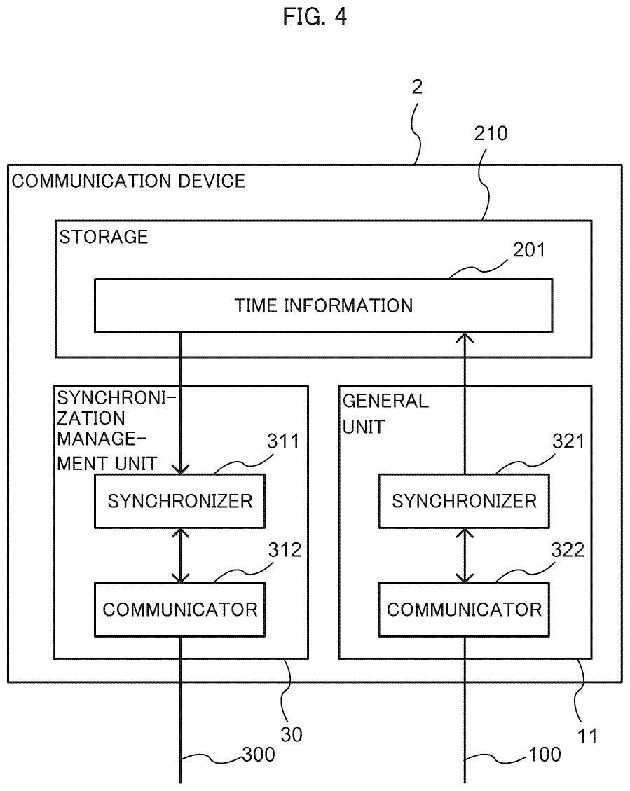

As illustrated in FIG. 4, the communication device 2 serving as the second communication device includes a storage unit 210 that stores time information 201 indicating a second time of another clock based on clock signals from the clock 904, the synchronization management unit 30 that executes a time synchronization process with the general units 31 to 33 of the communication devices 6 to 8 connected to the network 300, and the general unit 11 which is connected to the network 100 and of which the time is synchronized by the synchronization management unit 10 of the communication device 1.

The time information 201 retained by the communication device 2 corresponds to second time information indicating the second time matched to the time retained by the communication device 1, through the time synchronization process executed by the synchronization management unit 10 of the communication device 1. In the time synchronization system 1000, the time information 201 is used as the reference time of the network 300 connected to the synchronization management unit 30 included in the communication device 2.

The general unit 11 includes a synchronizer 321 (third synchronizer) that executes a time synchronization process through communication with the synchronization management unit 10 of the communication device 1, and a communicator 322 that communicates with the synchronization management unit 10. The synchronization management unit 30 includes a synchronizer 311 (fourth synchronizer) that executes a time synchronization process, and a communicator 312 that communicates with the general units 31 to 33. The time synchronization processes of the synchronizers 321 and 311 are pursuant to the IEEE 1558 protocol or the IEEE 802.1AS protocol.

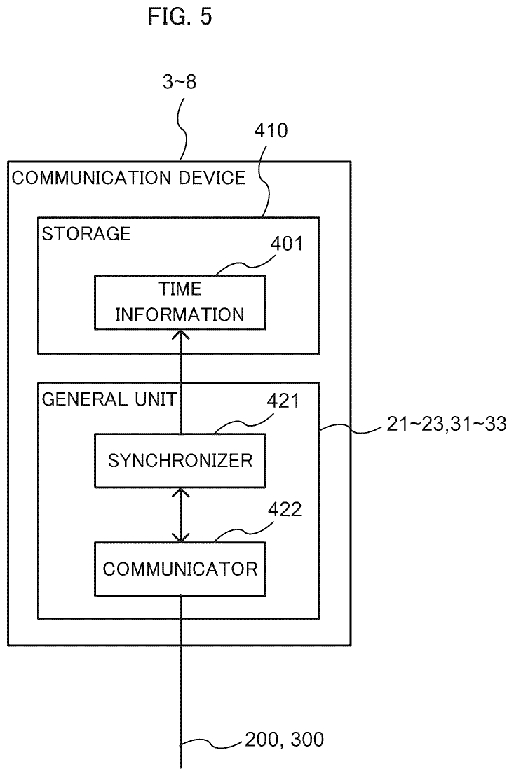

As illustrated in FIG. 5, each of the communication devices 3 to 5, serving as the third communication device excluding a synchronization management unit, functions as a storage unit 410 that stores time information 401 of another clock based on clock signals from the clock 904, and any of the general units 21 to 23 which are connected to the network 200 and of which the time is synchronized by the synchronization management unit 20 of the communication device 1.

The same holds true for the communication devices 6 to 8 serving as the third communication devices connected to the communication device 2 serving as the second communication device. That is, as illustrated in FIG. 5, each of the communication devices 6 to 8 functions as a storage unit 410 that stores time information 401 based on clock signals from the clock 904, and any of the general units 31 to 33 which are connected to the network 300 and of which the time is synchronized by the synchronization management unit 30 of the communication device 2.

The time information 401 retained by the communication devices 3 to 5 indicates the time matched to the time retained by the communication device 1, through the time synchronization process executed by the synchronization management unit 20 of the communication device 1. The time information 401 retained by the communication devices 6 to 8 indicates the time matched to the time retained by the communication device 2, through the time synchronization process executed by the synchronization management unit 30 of the communication device 2. The general units 21 to 23 and 31 to 33 included in the communication devices 3 to 8 operate on the basis of the time information 401.

Each of the general units 21 to 23 and 31 to 33 includes a synchronizer 421 that executes a time synchronization process through communication with the synchronization management unit 20 of the communication device 1 or the synchronization management unit 30 of the communication device 2, and a communicator 422 that communicates with the synchronization management unit 20 or 30. The time synchronization process of the synchronizer 421 is pursuant to the IEEE 1558 protocol or the IEEE 802.1AS protocol.

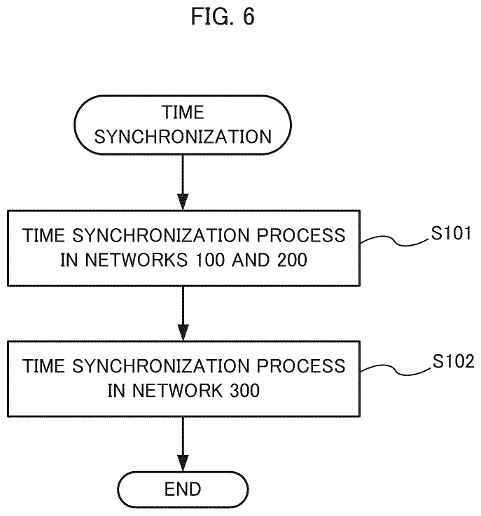

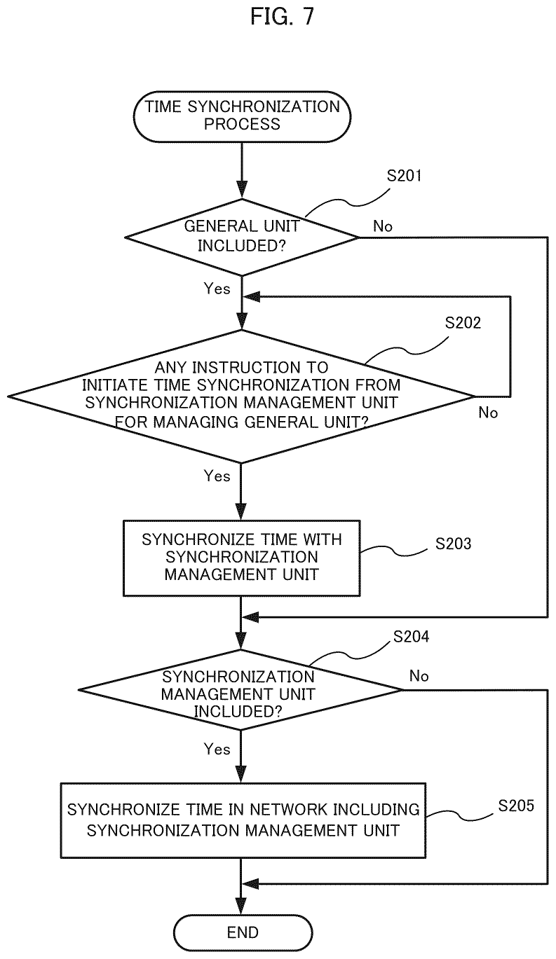

The following describes operations of the time synchronization system 1000 having the above-described configuration, with reference to the flowcharts of FIGS. 6 and 7. FIG. 6 is a flowchart illustrating the time synchronization of the entire time synchronization system 1000, and FIG. 7 is a flowchart illustrating the time synchronization process of each of the communication devices 1 to 8.

The time synchronization in the time synchronization system 1000 first involves time synchronization processes based on the first time information, executed by communication devices in the network including the first communication device including the first and second synchronization management units. That is, as illustrated in FIG. 6, the synchronization management unit 10 of the communication device 1 serving as the first communication device executes a time synchronization process with the general unit 11 in the network 100, and the synchronization management unit 20 executes a time synchronization process with the general units 21 to 23 in the network 200 (Step S101: first time synchronization step).

The time synchronization then involves a time synchronization process based on the second time information indicating the time synchronized in Step S101, executed by communication devices in the network including the third synchronization management unit included in the second communication device. That is, the synchronization management unit 30 of the communication device 2 executes a time synchronization process with the general units 31 to 33 in the network 300 (Step S102: second time synchronization step).

As illustrated in FIG. 7, the processor 901 of each of the communication devices 1 to 8 first determines whether the communication device includes a general unit (Step S201). When no general unit is included (Step S201: No), the process goes to Step S204. In contrast, when a general unit is included (Step S201: Yes), the general unit waits unless an instruction to initiate time synchronization is received from the synchronization management unit that manages this general unit (Step S202: No).

Specifically, the general unit 11 of the communication device 2 waits until reception of an instruction to initiate time synchronization from the synchronization management unit 10, the general units 21 to 23 of the communication devices 3 to 5 wait until reception of an instruction to initiate time synchronization from the synchronization management unit 20, and the general units 31 to 33 of the communication devices 6 to 8 wait until reception of an instruction to initiate time synchronization from the synchronization management unit 30.

When each of the general units 11, 21 to 23, and 31 to 33 of the communication devices 2 to 8 receives an instruction to initiate time synchronization from any of the synchronization management units 10, 20, and 30 (Step S202: Yes), this general unit synchronizes its time with the synchronization management unit 10, 20, or 30 (Step S203). This time synchronization process is pursuant to the IEEE 1558 protocol or the IEEE 802.1AS protocol. The time synchronization process matches the times of the communication devices 2 to 5 to the time retained by the communication device 1, and matches the times of the communication devices 6 to 8 to the time retained by the communication device 2.

The processor 901 of each of the communication devices 2 to 8 then determines whether the communication device includes a synchronization management unit (Step S204). When no synchronization management unit is included (Step S204: No), the process is terminated. In contrast, when a synchronization management unit is included (Step S204: Yes), the synchronization management unit executes a time synchronization process with the general units in the network including the synchronization management unit (Step S205), followed by termination of the time synchronization process.

Specifically, the synchronization management unit 10 of the communication device 1 executes a time synchronization process with the general unit 11 in the network 100, and the synchronization management unit 20 executes a time synchronization process with the general units 21 to 23 in the network 200. The synchronization management unit 30 of the communication device 2 executes a time synchronization process with the general units 31 to 33 in the network 300.

The communication device 1 excluding a general unit and including the synchronization management units 10 and 20 achieves time synchronization in the networks 100 and 200 in Step S205 among the steps illustrated in FIG. 7 (Step S101 in FIG. 6). The general unit 11 of the communication device 2 is then synchronizes its time with the synchronization management unit 10 in Step S203. The synchronization management unit 30 then achieves time synchronization in the network 300 (Step S102 in FIG. 6).

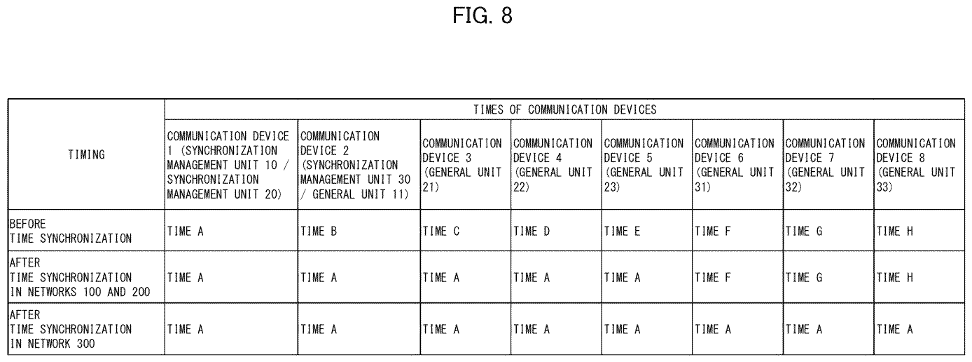

The following describes exemplary time synchronization, with reference to FIG. 8. FIG. 8 illustrates exemplary pieces of time information retained by the individual communication devices at several timings of FIG. 6.

In FIG. 8, the communication devices 1, 2, 3, 4, 5, 6, 7, and 8 before the time synchronization processes retain mutually different times A, B, C, D, E, F, G, and H. In Step S101 in FIG. 6, the synchronization management unit 10 included in the communication device 1 executes the time synchronization process with the general unit 11 connected via the network 100. This time synchronization process matches the time retained by the general unit 11 to the time retained by the synchronization management unit 10.

In Step S101 in FIG. 6, the synchronization management unit 20 included in the communication device 1 executes the time synchronization process with the general units 21 to 23 connected via the network 200. This time synchronization process matches the times retained by the general units 21 to 23 to the time retained by the synchronization management unit 20. The time synchronization process in the network 100 by the synchronization management unit 10 and the time synchronization process in the network 200 by the synchronization management unit 20 may be executed in any order.

The time synchronization processes by the synchronization management units 10 and 20 are based on the first time indicated by the identical time information 101. These time synchronization processes thus match the time retained by the communication device 2 connected to the network 100 and the times of the communication devices 3, 4, and 5 connected to the network 200, to the time A retained by the communication device 1, as illustrated in FIG. 8.

In Step S102 in FIG. 6, the synchronization management unit 30 included in the communication device 2 executes the time synchronization process with the general units 31 to 33 connected via the network 300. This time synchronization process matches the times of the general units 31 to 33 to the time of the synchronization management unit 30. The time retained by the communication device 2 is equal to the time A retained by the communication device 1, due to the time synchronization process with the communication device 1 in Step S101. That is, the time synchronization process by the synchronization management unit 30 in Step S102 matches the times retained by the general units 31 to 33 to the time A retained by the synchronization management unit 20.

Steps S101 and S102 thus match the times of all the communication devices connected to the networks 100, 200, and 300 to the time A.

As described above, in the time synchronization system 1000 according to the embodiment, the synchronization management units 10 and 20 of the communication device 1 execute time synchronization processes with the general units 11 and 21 to 23 connected via the networks 100 and 200, on the basis of the time information 101 indicating a time of the clock. The synchronization management unit 30 of the communication device 2 including the general unit 11 then executes a time synchronization process with the general units 31 to 33 connected via the network 300, on the basis of the time information 201 indicating the synchronized time. These processes can achieve time synchronization across networks.

The hardware configurations and flowcharts in the above-described embodiment are mere examples and may be arbitrarily varied and modified. For example, although the communication device 1 includes the synchronization management units 10 and 20 in the above-described embodiment, the communication device 1 may include three or more synchronization management units and achieve time synchronization in three or more networks.

Although each of the communication devices 3 to 8 includes the general unit in the above-described embodiment, the communication device may further include a synchronization management unit, which may synchronize its time with a general unit of a communication device connected via another network.

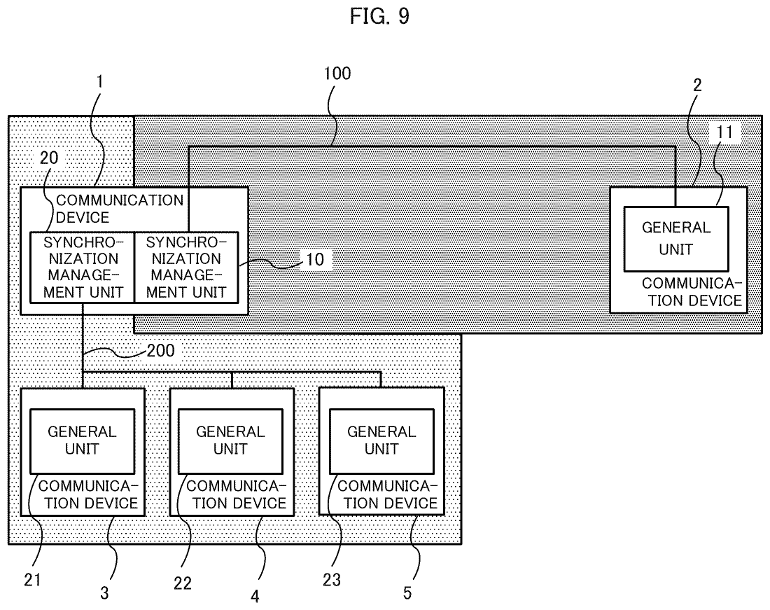

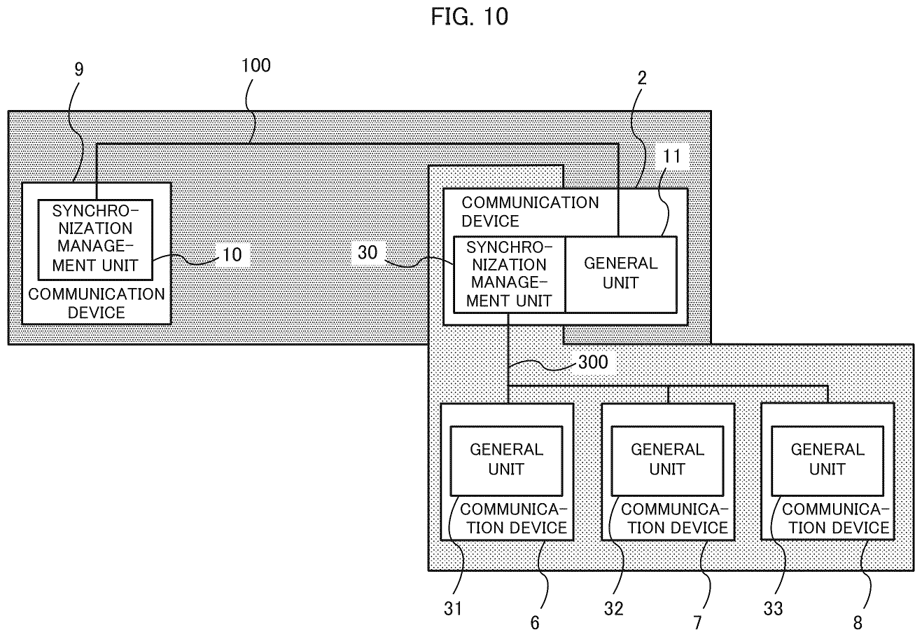

Although the time synchronization system includes the first communication device (communication device 1) including the synchronization management units 10 and 20, the second communication device (communication device 2) including the synchronization management unit 30 and the general unit 11, and the third communication devices (communication devices 3 to 8) each including any of the general units 21 to 23 and 31 to 33 alone in the above-described embodiment, this configuration is a mere example. FIGS. 9 and 10 are each a block diagram illustrating an exemplary entire configuration of a time synchronization system according to a modification of the embodiment.

As illustrated in FIG. 9, the time synchronization system may exclude the second communication device, and include the first communication device (communication device 1) including the synchronization management units 10 and 20, and third communication devices (communication devices 2 to 5) each including any of the general units 11 and 21 to 23, for example. Alternatively, as illustrated in FIG. 10, the time synchronization system may exclude the first communication device, and include a communication device (communication device 9) including the synchronization management unit 10 alone, the second communication device (communication device 2) including the synchronization management unit 30 and the general unit 11, and the third communication devices (communication devices 6 to 8) each including any of the general units 31 to 33. Alternatively, the communication device (communication device 9) including the synchronization management unit 10 alone may be connected in series to second communication devices (communication devices 2) each including the synchronization management unit 30 and the general unit 11.

Although the time synchronization between each synchronization management unit and each general unit is achieved by matching of the times to the first time retained by the communication device 1 in the above-described embodiment, this configuration is a mere example. The time synchronization may also be achieved by matching of the times to the time retained by another communication device or a third time. Alternatively, the synchronization management unit or the general unit of each communication device may achieve time synchronization by retaining the difference of the own time from a certain time, without matching of the own time to a certain time.

The assignment of the functions of the processor 901 of each of the communication devices 1 to 8 in the above-described embodiment is a mere example and may be arbitrarily modified. The functions of the processor 901 may be achieved by not only a dedicated system but a computer system having ordinary communication functions.

A program for achieving the operations in the above-described embodiment may be stored in non-transitory computer-readable recording mediums, such as compact disc read-only memories (CD-ROMs), digital versatile discs (DVDs), magneto optical (MO) discs, and memory cards, and distributed. The program may then be installed in a computer, and thus cause the computer to perform the functions. In the case where the functions are achieved by sharing of an operating system (OS) and an application or by cooperation of the OS and the application, only the components other than the OS may be stored in a non-transitory recording medium.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1-9 Communication device
10, 20, 30 Synchronization management unit
11, 21, 22, 23, 31, 32, 33 General unit
100, 200, 300 Network
101, 201, 401 Time information
110, 210, 410 Storage unit
111, 211, 311, 321, 421 Synchronizer
112, 212, 312, 322, 422 Communicator
901 Processor
902 Primary storage
903 Secondary storage
904 Clock
905 Inputter
906 Outputter
907 Communication interface
908 Internal bus
1000 Time synchronization system

1. A communication device including at least one of a general unit or one or more synchronization management units, the general unit and the one or more synchronization management units being each configured to execute a time synchronization process with another communication device, the communication device comprising:
a processor to
determine whether the communication device includes the one or more synchronization management units, and
when a determination is made that the communication device includes the one or more synchronization management units and the one or more synchronization management units are two synchronization management units,
cause a first synchronization management unit of the one or more synchronization management units that is connected to a first network, to execute a time synchronization process with a first general unit based on a first time of a certain clock, the first general unit being included in another communication device connected to the communication device via the first network, and
cause a second synchronization management unit of the one or more synchronization management units that is connected to a second network different from the first network, to execute a time synchronization process with a second general unit based on the first time, the second general unit being included in still another communication device connected to the communication device via the second network.

2. The communication device according to claim 1, wherein
the first synchronization management unit matches a time of the first general unit to the first time, the first general unit being connected to the first synchronization management unit via the first network, and
the second synchronization management unit matches a time of the second general unit to the first time, the second general unit being connected to the second synchronization management unit via the second network.

3. A communication device including at least one of a general unit or one or more synchronization management units, the general unit and the one or more synchronization management units being each configured to execute a time synchronization process with another communication device, the communication device comprising:
a processor to
determine whether the communication device includes the general unit,
when a determination is made that the communication device includes the general unit, cause a first general unit that is the general unit connected to a first network to executes a time synchronization process with a first synchronization management unit, the first synchronization management unit being included in another communication device connected to the communication device via the first network,
determine whether the communication device includes the one or more synchronization management units, and
when a determination is made that the communication device includes the one or more synchronization management units, cause a third synchronization management unit of the one or more synchronization management units that is connected to a third network different from the first network to execute a time synchronization process based on a second time synchronized by the first general unit, with a third general unit, the third general unit being included in still another communication device connected to the communication device via the third network.

4. The communication device according to claim 3, wherein
the first general unit matches a time thereof to a time of the first synchronization management unit, the first synchronization management unit being connected to the first general unit via the first network, and
the third synchronization management unit matches a time of the third general unit to the time matched by the first general unit to the time of the first synchronization management unit, the third general unit being connected to the third synchronization management unit via the third network.

5. A time synchronization system, comprising:
at least one of the communication device according to claim 1.

6. (canceled)

7. A non-transitory computer-readable recording medium storing a program for a computer of a communication device including at least one of a general unit or one or more synchronization management units, the general unit and the one or more synchronization management units being each configured to execute a time synchronization process with another communication device, the program being configured to:
cause the computer to determine whether the communication device includes the one or more synchronization management units, and
when a determination is made that the communication device includes the one or more synchronization management units and the one or more synchronization management units are two synchronization management units, cause the computer to function as:
a first synchronizer to execute a time synchronization process based on a first time of a certain clock with another computer, the another computer being connected to the computer via a first network and functioning as a first general unit; and
a second synchronizer to execute a time synchronization process based on the first time with still another computer, the still another computer being connected to the computer via a second network different from the first network and functioning as a second general unit.

8. A non-transitory computer-readable recording medium storing a program for a computer of a communication device including at least one of a general unit or one or more synchronization management units, the general unit and the one or more synchronization management units being each configured to execute a time synchronization process with another communication device, the program being configured to:
cause the computer to determine whether the communication device includes the general unit,
when a determination is made that the communication device includes the general unit, cause the computer to function as a third synchronizer to execute a time synchronization process with another computer, the another computer being connected to the computer via a first network and functioning as a first synchronization management unit,
cause the computer to determine whether the communication device includes the one or more synchronization management units, and
when a determination is made that the communication device includes the one or more synchronization management units, cause the computer to function as a fourth synchronizer to execute a time synchronization process based on a time synchronized by the third synchronizer, with still another computer, the still another computer being connected to the computer via a third network different from the first network and functioning as a third general unit.

9. A time synchronization system, comprising:
the communication device according to claim 2.

10. A time synchronization system, comprising:
the communication device according to claim 3.

11. A time synchronization system, comprising:
the communication device according to claim 4.
